(19) United States
(12) Patent Application Publication
(10) Pub. No.: US 2026/0352558 A1
(43) Pub. Date: Nov. 5, 2026

(54) METHODS FOR ONLINE TRAINING FOR DEVICES PERFORMING AI/ML BASED CSI FEEDBACK

(71) Applicant: INTERDIGITAL PATENT HOLDINGS, INC., Wilmington, DE (US)

(72) Inventors: Arnab Roy, Phoenixville, PA (US); Patrick Tooher, Montreal (CA); Akshay Malhotra, San Jose, CA (US); Yugeswar Deenoo Narayanan Thangaraj, Chalfont, PA (US); Moon IL Lee, Melville, NY (US); Mohamed Salah Ibrahim, Chesterbrook, PA (US); Arman Shojaeifard, London (GB); Ibrahim Hemadeh, Hemel Hempstead (GB); Mihaela Beluri, Jericho, NY (US)

(73) Assignee: INTERDIGITAL PATENT HOLDINGS, INC., Wilmington, DE (US)

(21) Appl. No.: 19/100,004

(22) PCT Filed: Aug. 1, 2023
(86) PCT No.: PCT/US2023/029180

§ 371 Date: Jan. 30, 2025

Related U.S. Application Data
(60) Provisional application No. 63/394,167, filed on Aug. 1, 2022.

(51) Int. Cl. H04L 41/16; H04B 7/06

(52) U.S. Cl. CPC H04L 41/16; H04B 7/0626

(57) ABSTRACT

As described herein, there are one or more techniques concerning the performance of training for one or more wireless transmit receive unit(s) (WTRU) configured for generating artificial intelligence and/or machine learning based channel state information feedback.

### CROSS-REFERENCE TO RELATED APPLICATIONS

The present application claims the benefit of and priority to U.S. Provisional Patent Application No. 63/394,167, entitled “Methods for Online Training for Devices Performing AI/ML Based CSI Feedback,” filed Aug. 1, 2022, the entirety of which is incorporated by reference herein.

### SUMMARY

As described herein, there are one or more techniques concerning the performance of training for one or more wireless transmit receive unit(s) (WTRU) configured for generating artificial intelligence and/or machine learning based channel state information feedback.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a configuration for CSI reporting settings, resource settings, and link.

FIG. 3 illustrates an example of codebook-based precoding with feedback information;

FIG. 4 illustrates an example table of downlink codebook for 2Tx;

FIG. 5 illustrates an example procedure for AI/ML encoder model online update;

FIG. 6 illustrates another example procedure for AI/ML encoder model online update; and

FIG. 7 illustrates an example procedure for AI/ML decoder model online update.

### DETAILED DESCRIPTION

Table 1 is a non-exhaustive list of acronyms that may be used herein.

TABLE 1

| | |
|---|---|
| Δf | Sub-carrier spacing |
| gNB | NR NodeB |
| ACK | Acknowledgement |
| AE | Autoencoder |
| AI | Artificial Intelligence |
| AI/ML | Artificial Intelligence/Machine Learning |
| BLER | Block Error Rate |
| BWP | Bandwidth Part |
| CAP | Channel Access Priority |
| CAPC | Channel access priority class |
| CCA | Clear Channel Assessment |
| CCE | Control Channel Element |
| CE | Control Element |
| CG | Configured grant or cell group |
| CP | Cyclic Prefix |
| CP-OFDM | Conventional OFDM (relying on cyclic prefix) |
| CQI | Channel Quality Indicator |
| CRC | Cyclic Redundancy Check |
| CSI | Channel State Information |
| CW | Contention Window |
| CWS | Contention Window Size |
| CO | Channel Occupancy |
| CU | Central Unit |
| D2D | Device to Device transmissions (e.g., LTE Sidelink) |
| DAI | Downlink Assignment Index |
| DCI | Downlink Control Information |
| DFI | Downlink feedback information |
| DG | Dynamic grant |
| DL | Downlink |
| DM-RS | Demodulation Reference Signal |
| DRB | Data Radio Bearer |
| DU | Distributed Unit |
| EN-DC | E-UTRA - NR Dual Connectivity |
| EPC | Evolved Packet Core |
| FDD | Frequency Division Duplexing |
| FDM | Frequency Division Multiplexing |
| eLAA | enhanced Licensed Assisted Access |
| FeLAA | Further enhanced Licensed Assisted Access |
| HARQ | Hybrid Automatic Repeat Request |
| LAA | License Assisted Access |
| LBT | Listen-Before-Talk |
| LTE | Long Term Evolution e.g. from 3GPP LTE R8 and up |
| NACK | Negative ACK |
| MCS | Modulation and Coding Scheme |
| MIMO | Multiple Input Multiple Output |
| ML | Machine Learning |
| MTC | Machine-Type Communications |
| MR-DC | Multi-RAT Dual Connectivity |
| NR | New Radio |
| OFDM | Orthogonal Frequency-Division Multiplexing |
| OOB | Out-Of-Band (emissions) |
| Pcmax | Total available WTRU power in a |
| | given transmission interval |
| Pcell | Primary cell of Master Cell Group |
| PScell | Primary cell of a Secondary cell group |
| PCG | Primary Cell Group |
| PDU | Protocol Data Unit |
| PER | Packet Error Rate |
| PHY | Physical Layer |
| PRB | Physical Resource Block |
| PID | Process ID |
| PO | Paging Occasion |
| PRACH | Physical Random Access Channel |
| PSS | Primary Synchronization Signal |
| RA | Random Access (or procedure) |
| RACH | Random Access Channel |
| RAR | Random Access Response |
| RCU | Radio access network Central Unit |
| RF | Radio Front end |
| RLF | Radio Link Failure |
| RLM | Radio Link Monitoring |
| RNTI | Radio Network Identifier |
| RO | RACH occasion |
| RRC | Radio Resource Control |
| RRM | Radio Resource Management |
| RS | Reference Signal |
| RSRP | Reference Signal Received Power |
| RSSI | Received Signal Strength Indicator |
| RTT | Round-Trip Time |
| SDU | Service Data Unit |
| SRS | Sounding Reference Signal |
| SS | Synchronization Signal |
| SSS | Secondary Synchronization Signal |
| SWG | Switching Gap (in a self-contained subframe) |
| SPS | Semi-persistent scheduling |
| SUL | Supplemental Uplink |
| TB | Transport Block |
| TBS | Transport Block Size |
| TDD | Time-Division Duplexing |
| TDM | Time-Division Multiplexing |
| TI | Time Interval (in integer multiple of one or more symbols) |
| TTI | Transmission Time Interval (in integer |
| | multiple of one or more symbols) |
| TRP | Transmission/Reception Point |
| TRPG | Transmission/Reception Point Group |
| TRx | Transceiver |
| TSC | Time-sensitive communications |
| TSN | Time-sensitive networking |
| UL | Uplink |
| URLLC | Ultra Reliable Low Latency Communication |
| WBWP | Wide Bandwidth Part |
| WLAN | Wireless Local Area Networks and related |
| | technologies (IEEE 802.xx domain) |
| NMSE | Normalized Mean Square Error |

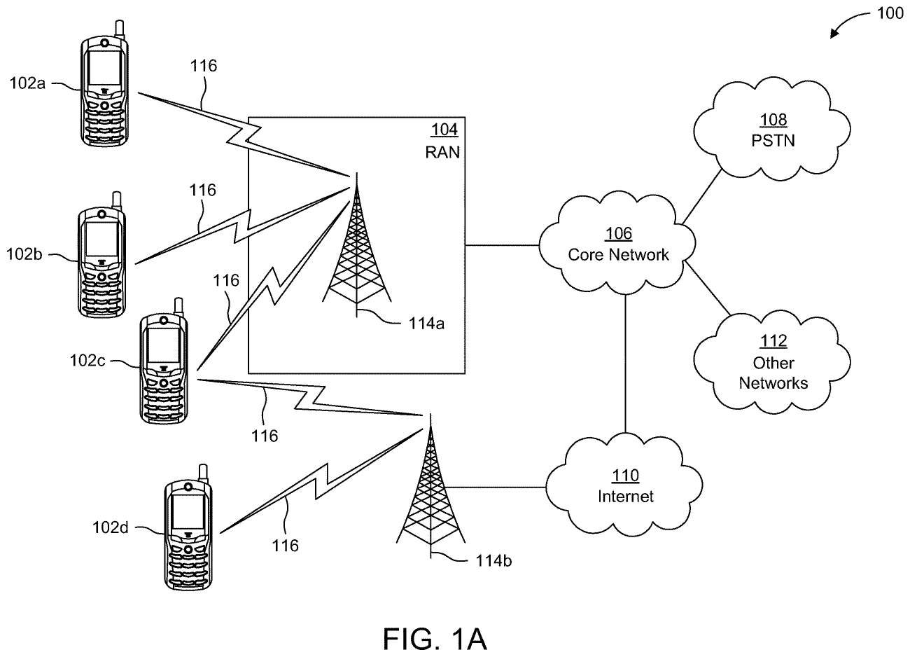

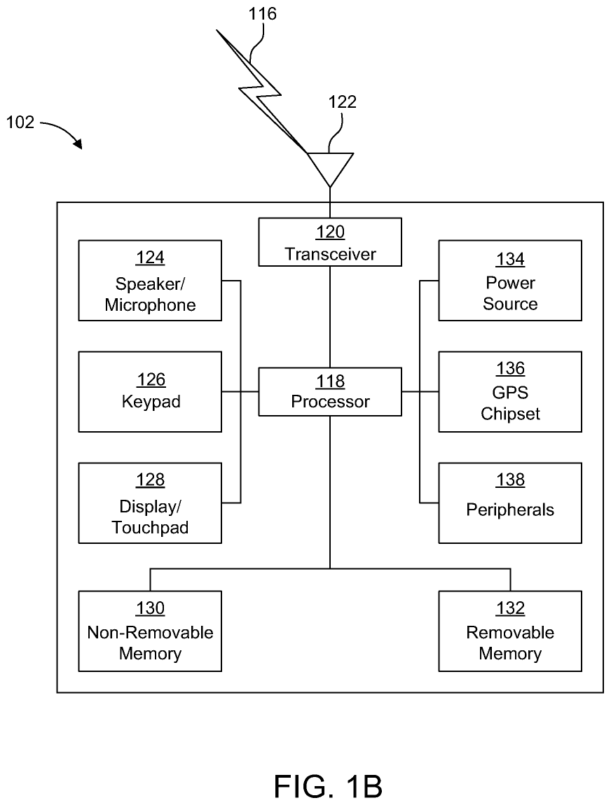

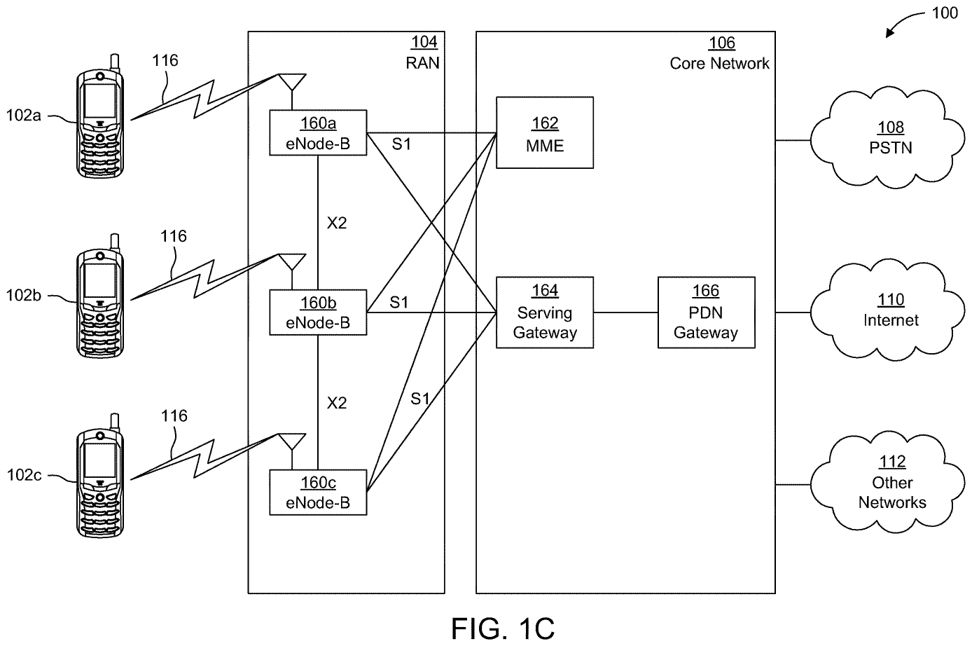

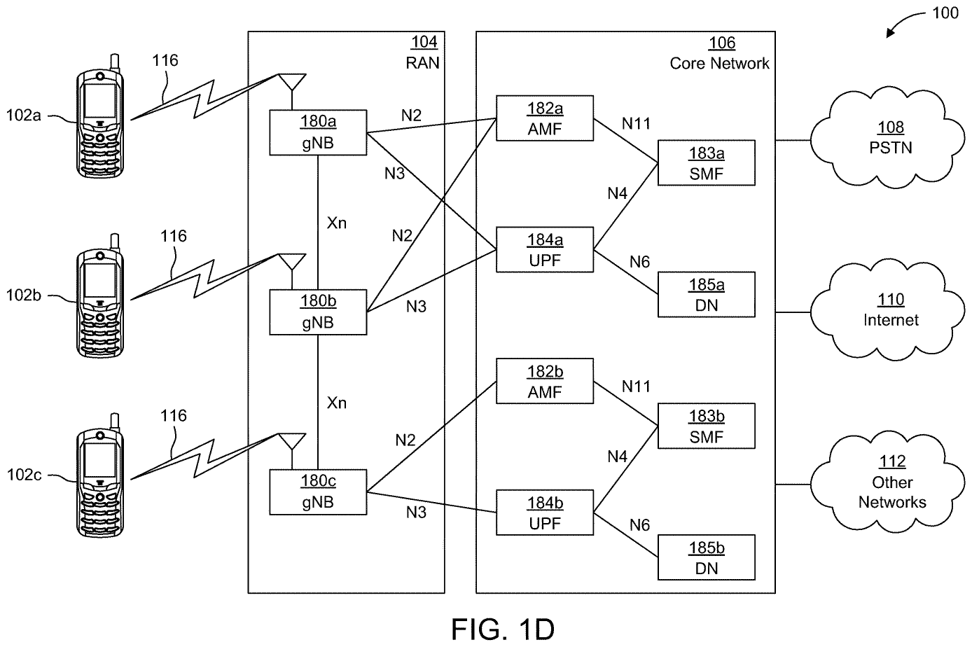

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

Generally, any network side device/node/function/base station, in FIGS. 1A-1D, and/or described anywhere herein, may be interchangeable, and reference to the network may mean reference to a specific entity, as disclosed herein, such as a device, node, function, base station, cloud, or the like.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Channel State Information (CSI) feedback enhancement, such as overhead reduction, improved accuracy, prediction, may be advantages gained from the use of artificial intelligence and/or machine learning (AI/ML) systems and algorithms as they relate to NR Air Interfaces. For example, in NR generally, there may be a large overhead associated with the Down Link (DL) CSI reference signals (CSI-RS), and the corresponding Up Link (UL) CSI reports. This overhead may increase as the system bandwidth and the number of antennas for Massive MIMO systems increase in NR Advanced and beyond.

ML techniques can enable a WTRU to compress the CSI measurements that it sends to the network (e.g., network node, network function, base station, gNB, etc., or any other type of network device). An AI/ML encoder at the WTRU may encode (e.g., compress) the measurements of channel conditions, which are then sent to the network, where they may be decompressed by an AI/ML decoder. The AI/ML encoder-decoder pair may be trained together as part of autoencoder (AE) structure, or trained separately.

To reduce WTRU complexity and/or also to reduce training latency, in some embodiments, the WTRU may be configured with a relatively small AI/ML encoder model containing a small number of weights. However, this implies that the AI/ML encoder may be no longer robust against all possible measurements of channel conditions. Therefore, in some further embodiments, the encoder may need to be re-trained as the observed channel conditions vary.

Channel State Information, may include at least one of the following: channel quality index (CQI), rank indicator (RI), precoding matrix index (PMI), an L1 channel measurement (e.g., RSRP such as L1-RSRP, or SINR), CSI-RS resource indicator (CRI), SS/PBCH block resource indicator (SSBRI), layer indicator (LI), and/or any other measurement quantity measured by the WTRU from the configured reference signals (e.g., CSI-RS or SS/PBCH block or any other reference signal).

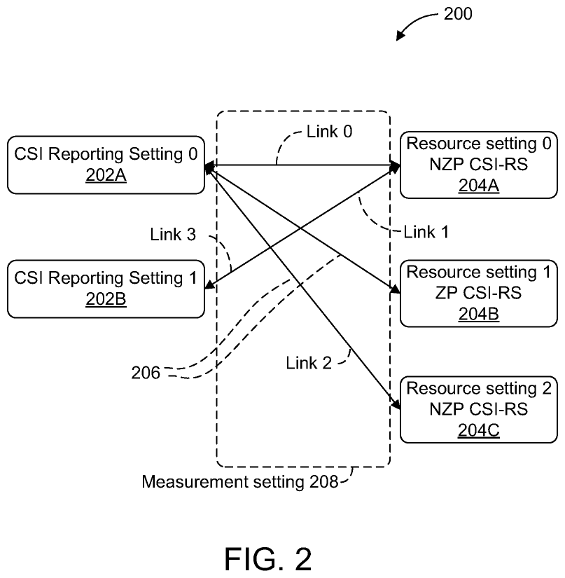

FIG. 2 shows an example of a configuration 200 for CSI reporting settings (e.g. CSI reporting settings 202A-202B), resource settings (e.g. resource settings 204A-204C), and links 206 (e.g. link 0-link 3).

A WTRU may be configured to report the CSI through the uplink control channel on PUCCH, or per the gNBs' request on an UL PUSCH grant. Depending on the configuration, CSI-RS may cover the full bandwidth of a BandWidth Part (BWP) or just a fraction of it. Within the CSI-RS bandwidth, CSI-RS may be configured in each PRB or every other PRB. In the time domain, CSI-RS resources may be configured either periodic, semi-persistent, or aperiodic. Semi-persistent CSI-RS may be similar to periodic CSI-RS, except that the resource can be (de)-activated by MAC CEs; and the WTRU reports related measurements only when the resource is activated. For Aperiodic CSI-RS, the WTRU may be triggered to report measured CSI-RS on PUSCH by request in a DCI. Periodic reports may be carried over the PUCCH, while semi-persistent reports can be carried either on PUCCH or PUSCH. The reported CSI may be used by the scheduler when allocating optimal resource blocks possibly based on channel's time-frequency selectivity, determining precoding matrices, beams, transmission mode and selecting suitable MCSs. The reliability, accuracy, and timeliness of WTRU CSI reports may be critical to meeting URLLC service requirements.

A WTRU may be configured with a CSI measurement setting 208 that may include one or more CSI reporting settings 202, resource settings 204, and/or a link 206 between one or more CSI reporting settings 202 and one or more resource settings 204. In some embodiments, a CSI measurement setting 208 may include at least one of the following: a CSI reporting setting 202; a resource setting 204; and/or, or for CQI, a reference transmission scheme setting.

A CSI measurement setting 208 may include one or more configuration parameters, as described herein.

For a CSI measurement setting 208, an example of a configuration parameter may be a N≥1 CSI reporting settings 202, a M≥1 resource setting 204, and one or more links 206 which links the N CSI reporting settings 202 with the M resource settings 204.

For a CSI measurement setting 208, another example of a configuration parameter may be a CSI reporting setting 202 that includes at least one of the following: a time-domain behavior, such as aperiodic or periodic/semi-persistent; a frequency-granularity, at least for PMI and CQI; a CSI reporting type (e.g., PMI, CQI, RI, CRI, etc.); and/or, if a PMI is reported, a PMI Type (Type I or II) and codebook configuration.

For a CSI measurement setting 208, another example of a configuration parameter may be a resource setting 202 that includes at least one of the following: a time-domain behavior, such as aperiodic or periodic/semi-persistent; an RS type (e.g., for channel measurement or interference measurement); and/or, S≥1 resource set(s), in which each resource set can contain Kₛ resources.

For a CSI measurement setting 208, another example of a configuration parameter may be one or more frequency granularities supported for CSI reporting for a component carrier, such as Wideband CSI; Partial band CSI; and/or Sub band CSI.

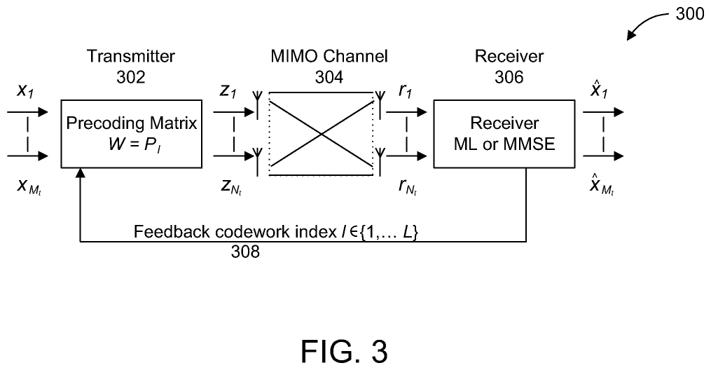

FIG. 3 illustrates an example of code-book based precoding with feedback information 300. The feedback information 308 may include a precoding matrix index (PMI) which may be referred to as a codeword index in the codebook as shown in the figure.

As shown, a codebook may include a set of precoding vectors/matrices for each rank and the number of antenna ports, and each of the precoding vectors/matrices may have its own index, such that a first device or WTRU (e.g. a receiver 306) may inform a preferred precoding vector/matrix index to a second device or WTRU (e.g. a transmitter 302) via one or more MIMO channels 304. The codebook-based precoding may have performance degradation due to its finite number of precoding vectors/matrices as compared with non-codebook-based precoding. However, an advantage of a codebook-based precoding could be lower control signaling/feedback overhead.

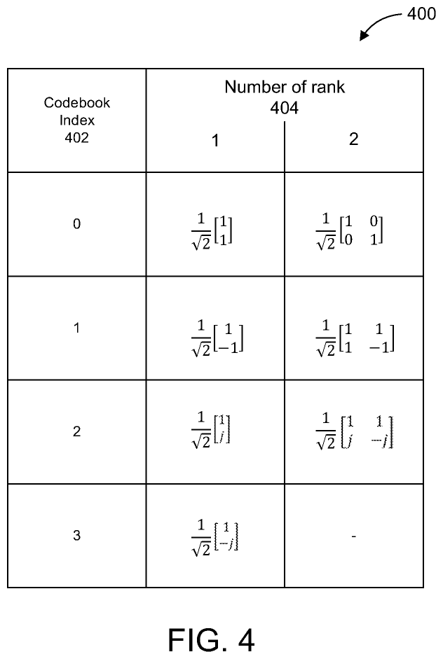

FIG. 4 illustrates an example of downlink codebook 400 for 2Tx. A CSI processing unit (CPU) may be referred to as a minimum CSI processing unit and a WTRU may support (e.g., run) one or more CPUs (e.g., N CPUs). A WTRU with N CPUs may estimate N CSI feedback calculations in parallel, wherein N may be a WTRU capability. If a WTRU is requested to estimate more than N CSI feedbacks at the same time, in some embodiments, the WTRU may only perform high priority N CSI feedbacks and the rest may not be estimated.

The start and end of processing for a CPU may be determined based on the CSI report type (e.g., aperiodic, periodic, semi-persistent). For example, for aperiodic CSI reports, a CPU starts to be occupied from the first OFDM symbol after the PDCCH trigger until the last OFDM symbol of the PUSCH carrying the CSI report. For periodic and semi-persistent CSI reports, a CPU starts to be occupied from the first OFDM symbol of one or more associated measurement resources (not earlier than CSI reference resource) until the last OFDM symbol of the CSI report.

The number of CPUs occupied may be different based on the CSI measurement types (e.g., beam-based or non-beam based). For example, for non-beam related reports, Kₛ CPUs may be occupied when Kₛ CSI-RS resources in the CSI-RS resource set are utilized for channel measurement. For beam-related reports (e.g., “cri-RSRP”, “ssb-Index-RSRP”, or “none”), 1 CPU may be occupied irrespective the number of CSI-RS resources in the CSI-RS resource set for channel measurement, as the CSI computation complexity is relatively low, and “none” is used for P3 operation or aperiodic TRS transmission. For an aperiodic CSI reporting with a single CSI-RS resource, 1 CPU may be occupied. For a CSI reporting Ks CSI-RS resources, Kₛ CPUs may be occupied as WTRU needs to perform CSI measurement for each CSI-RS resource.

When the number of unoccupied CPUs (Nᵤ) is less than the required CPUs (Nᵣ) for CSI reporting, one or more example WTRU behaviors may be used: The WTRU may drop Nᵣ-Nᵤ CSI reporting based on priorities in the case of UCI on PUSCH without data/HARQ; and/or, the WTRU may report dummy information in Nᵣ-Nᵤ CSI reporting based on priorities in other case to avoid rate-matching handling of PUSCH.

Generally, artificial intelligence (AI) may be broadly defined as the behavior exhibited by machines. Such behavior may, for example, mimic cognitive functions to sense, reason, adapt and act.

Generally, machine learning (ML) may refer to a type of algorithms that solve a problem based on learning through experience (‘data’), without explicitly being programmed (‘configuring set of rules’). Machine learning can be considered as a subset of AI. Different machine learning paradigms may be envisioned based on the nature of data or feedback available to the learning algorithm. In one example paradigm, a supervised learning approach may involve learning a function that maps input to an output based on labeled training examples, wherein each training example may be a pair consisting of input and the corresponding output. In one example paradigm, unsupervised learning approach may involve detecting patterns in the data with no pre-existing labels. In one example paradigm, reinforcement learning approach may involve performing sequence of actions in an environment to maximize the cumulative reward. In some approaches discussed herein, it is possible to apply machine learning algorithms using a combination or interpolation of the above-mentioned paradigms. For example, semi-supervised learning approach may use a combination of a small amount of labeled data with a large amount of unlabeled data during training. In this regard semi-supervised learning falls between unsupervised learning (with no labeled training data) and supervised learning (with only labeled training data).

Generally, deep learning refers to a class of machine learning algorithms that employ artificial neural networks (specifically Deep Neural Networks (DNNs)). The Deep Neural Networks (DNNs) are a special class of machine learning models inspired by human brain wherein the input is linearly transformed and pass-through non-linear activation function multiple times. DNNs typically consists of multiple layers where each layer consists of linear transformation and a given non-linear activation functions. The DNNs can be trained using the training data via back-propagation algorithm. Recently, DNNs have shown state-of-the-art performance in a variety of domains, such as speech, vision, natural language, etc. and for various machine learning settings supervised, un-supervised, and semi-supervised.

The term AI/ML may refer to techniques involving methods/processing, such as described herein, and may refer to a realization of behaviors and/or conformance to requirements by learning based on data, without explicit configuration of a sequence of steps of actions. Such methods may enable learning complex behaviors which might be difficult to specify and/or implement when using legacy methods.

The Normalized Mean Squared Error (NMSE) may be used to assess the quality of the CSI compression and reconstruction. The NMSE is defined as:

$$NMSE = E \{ {‖ H - \tilde{H} ‖}_{F}^{2} / {‖ H ‖}_{F}^{2} \} \qquad Eq . 1$$

where H represents the CSI matrix (e.g. channel response) at the AI NN encoder input, \tilde{H} represents the reconstructed matrix at the AI NN decoder output, and the operator ∥ ∥_{F} indicates the Frobenius (Euclidean) norm.

Another measure of the quality of the CSI compression and reconstruction is the cosine similarity, ρ, which is defined as:

$$ρ = E \{ \frac{1}{{N}_{c}} {\sum }_{n = 1}^{{N}_{c}} \frac{\vert {\tilde{h}}_{n}^{H} {h}_{n} \vert}{{‖ {\tilde{h}}_{n} ‖}_{2} {‖ {h}_{n} ‖}_{2}} \} \qquad Eq . 2$$

where \tilde{h}ₙ represents the vector on subcarrier “n” of the reconstructed channel matrix (at the output of the AI NN decoder).

AI encoder, AI/ML encoder, AI NN encoder, or AI/ML NN encoder may be used interchangeably herein. AI decoder, AI/ML decoder, AI NN decoder or AI/ML NN decoder may be used interchangeably herein. AI/ML training and retraining may be used interchangeably as discussed herein, unless otherwise indicated.

ML-based approaches for CSI compression may require datasets for training for a wide range of channel conditions. Performing this procedure online not only requires a very large amount of training data, but also incurs significant delays, power, and memory requirements at the WTRU. Training the encoder for a subset of the channel conditions before deployment and then updating it as additional data (e.g., measurements of channel conditions) become available may ameliorate some of these issues. Specifically, in some embodiments, the AI/ML encoder model at the WTRU may be trained independently from the autoencoder decoder at the network (e.g., gNB).

Certain updates to the WTRU AI/ML encoder model based on re-training using actual measurements may require corresponding updates to the network AI/ML decoder model as well. The required decoder updates may be efficiently communicated to the network, in some embodiments.

In some embodiments, the WTRU may initially use an encoder model that is trained for a subset of channel conditions. When the WTRU encounters channel conditions that are outside the original training set, it may request additional training data from the network. The WTRU AI/ML encoder may request appropriate additional training set(s) and determine when re-training is successful.

In some embodiments, a WTRU may be configured with one or more AI/ML models. The WTRU may use one or more AI/ML models to obtain CSI feedback reports for sending to the network. The WTRU may input CSI measurements (e.g., obtained from measurements performed on Reference Signals) into the AI/ML encoder and may feedback to the gNB the output of the AI/ML encoder.

An AI/ML model may be configured with one or more pieces of information, as described herein.

For instance, an AI/ML model configuration may include parameters related to the original training of the AI/ML model. For example, the model configuration may indicate the types of channels for which the AI/ML model is applicable. For example, the model configuration may indicate the source of the AI/ML model. The source may include a node identifier, or parameters associated with the conditions at the training node.

For instance, an AI/ML model may be configured to include datasets for training of the AI/ML model. The datasets for training of the AI/ML model may include at least one of: Synthetic datasets; Field datasets; measurement based datasets obtained at least in part by reference signal configurations, wherein the WTRU may be provided reference signal configurations; and/or, data set(s) from other nodes, wherein the WTRU may be provided resources on which to receive data from other nodes.

For instance, an AI/ML model may be configured to include AI/ML model performance thresholds. Such thresholds may be compared to the error of the AI/ML encoder output. Such thresholds may be compared to the performance of a function associated with the AI/ML model. For example, a threshold may be compared to the compression rate of a feedback reporting AI/ML function.

For instance, an AI/ML model may be configured to include AI/ML model performance reporting resources. For example, a WTRU may be configured with reporting resources to report the performance of an AI/ML model.

For instance, an AI/ML model may be configured to include training request resources. For example, a WTRU may be configured with resources on which it may transmit to another node (e.g., a gNB) a request for training (e.g., a request for either datasets for training, or for transmission of signals, such as reference signals, that enable the WTRU to train the AI/ML model on-line) of an AI/ML model.

A WTRU may use an AI/ML model if it is determined to be suitable based on one or more criteria. Suitability may be determined if the AI/ML model satisfies at least one reporting criterion. For example, an AI/ML model may be deemed suitable if it satisfies a compression rate criterion. In this example, a WTRU may deem an AI/ML model suitable if its compression rate is greater than or less than a configurable threshold. In another example, an AI/ML model may be deemed suitable if it satisfies an error (e.g., MMSE) criterion. In this example, a WTRU may deem an AI/ML model suitable if its error or MMSE is less than a configurable threshold.

Depending on a compression rate obtained for a suitable AI/ML model, the WTRU may require different payload sizes for the CSI feedback report. The WTRU may be configured with one or more CSI feedback reporting resources. For example, a WTRU may have a set of CSI feedback reporting resources, each suitable for different compression rates (or feedback payload). A WTRU may be configured with CSI feedback reporting resources for a fallback CSI report. Where a fallback CSI report may be obtained using legacy methods (e.g., without use of AI/ML). Such a fallback CSI report may be transmitted by the WTRU when no AI/ML model is deemed suitable.

A WTRU may be configured with training occasions and/or resources. The training occasions may occur periodically, aperiodically or semi-periodically. Training occasions may be configured with at least one of: periodicity, offset, start time, and/or end time.

A WTRU may be triggered to perform AI/ML training by one or more factors/events.

A WTRU may be triggered to perform AI/ML training by timing. For example, for periodically configured training occasions, the WTRU may train the model at configurable time intervals.

A WTRU may be triggered to perform AI/ML training by reception of an indication from the network (e.g., gNB). For example, for aperiodic or semi-persistent training occasions, the WTRU may begin training upon reception of an indication from the gNB. The training indication may a dynamic indication (e.g., in a DCI or MAC CE) or a non-dynamic indication (e.g., RRC indication). A training indication may be implicitly received by the WTRU as part of a reconfiguration of a function associated with the AI/ML model. For example, if an AI/ML model is configured for CSI feedback reporting, when the WTRU receives a reconfiguration of one or more CSI feedback reporting, the WTRU may be triggered to begin an AI/ML model training.

A WTRU may be triggered to perform AI/ML training based on performance of the WTRU. For example, the WTRU may be triggered to perform AI/ML training based on at least one of: BLER performance (e.g., BLER performance below or above a threshold); HARQ-ACK or HARQ-NACK ratio; Measurements, such as if an L3 (e.g., RSRP, RSSI, RSRQ, CO) or L1 measurement (e.g., RI, PMI, CQI, LI, CRI, RSRP) goes above or below a threshold value, the WTRU may be triggered to begin training an AI/ML model; Change of BWP; Change or addition or removal or activation or deactivation of a cell; Change of TRP; and/or, Feedback payload size.

A WTRU may be triggered to perform AI/ML training by performance of a model. For example, a WTRU may be triggered to perform AI/ML model training based on at least one of: AI/ML output error (e.g., MMSE error) and/or compression rate.

For AI/ML output error, for example, a WTRU may be configured with an AI/ML encoder and a decoder (e.g., a decoder used by the gNB). The WTRU may test the output of the decoder with the actual channel measurement and may determine an error value. If the error value is greater than, less than, and/or equal to a threshold, the WTRU may be triggered to begin training the AI/ML model. The WTRU may be triggered to train an AI/ML model when the error is greater than a threshold because such an error may lead to reduced performance. The WTRU may be triggered to train an AI/ML model when the error is less than a threshold, because this may mean higher feedback compression may be possible.

For compression rate, for example, a WTRU may be triggered to begin training an AI/ML model when the compression rate is greater than a threshold. In such a case, a lower AI/ML error may be achievable for a lower compression rate that is still suitable. In another example, a WTRU may be triggered to begin training an AI/ML model when the compression rate is less than a threshold. In such a case, a greater compression rate may be possible with an acceptable error rate.

A WTRU may be triggered to perform AI/ML training by time since a last training occasion. For example, a WTRU may be configured with a time period. The WTRU may start or restart the timer when first configured with an AI/ML model or when training for an AI/ML model is completed. Upon expiration of the time period, the WTRU may begin training the AI/ML model.

The WTRU may receive an RS configuration when triggered to perform AI/ML model training. The WTRU may use such resources to obtain channel conditions to train the AI/ML model.

When a WTRU is triggered to train an AI/ML model, the WTRU may indicate to the gNB that it is beginning AI/ML model training. The indication may include the trigger or cause for the training and may also include the function associated with the AI/ML model.

A WTRU may be triggered to request an AI/ML model training occasion from the gNB. The triggers may include any of the above triggers. When a WTRU is triggered to request an AI/ML model training occasion, the WTRU may report such a request, for example, on a resource configured for such a request.

A training occasion may last multiple slots or subframes. During this time, a WTRU may have CSI feedback report instances. In such instances a WTRU may transmit feedback using the AI/ML model established prior to retraining, or the new model being trained or legacy feedback (e.g., not based on AI/ML models).

A WTRU may test an AI/ML model to determine if it is suitable. The testing of the AI/ML model may be done after the training occasion has ended. The testing of the AI/ML model may be done concurrently to the AI/ML model training. A WTRU may test the AI/ML model after every x update of the model during the training occasion, where x>=1. The testing of the AI/ML model may be achieved similarly to the model performance described herein. A WTRU may be configured with an AI/ML decoder (e.g., the AI/ML decoder used at the gNB). The WTRU may perform one or more CSI measurements on one or more RSs. The WTRU may input the CSI measurements into the AI/ML encoder model. The WTRU may determine a compression rate of the output of the encoder model. The WTRU may then input the output of the encoder model into the decoder model. The WTRU may compare the output of the decoder model with the originally obtained CSI measurements. Based on the comparison, the WTRU may adjust some parameters of either the encoder or the decoder AI/ML models.

A WTRU may stop training an AI/ML model when one or more ending condition(s) is satisfied.

For instance, an AI/ML training ending condition may include an expiration of a training occasion time or duration. For example, a training occasion may be configured with a training occasion time or duration. In some embodiments, the training time may be a number of slots, subframes, or RS instances, or may be based on a temporal period such as a number of seconds, minutes, or any other time.

For instance, an AI/ML training ending condition may include when a compression rate achieves a required value. For example, the training occasion may end when a compression rate becomes greater than a threshold value. The value may be predetermined or may be provided to the WTRU when training is triggered.

For instance, an AI/ML training ending condition may include when an error performance achieves a required value. For example, the training occasion may end when an error performance (e.g., MMSE) becomes less than a threshold value. The value may be predetermined or may be provided to the WTRU when training is triggered.

For instance, an AI/ML training ending condition may include when a model performance is not converging. For example, if an error performance worsens or the compression rate decreases, the WTRU may end AI/ML model training. A WTRU may compare an error performance to either the performance achieved prior to training (or an offset thereof) or to a threshold. When the performance becomes worse than the offset or threshold, the WTRU may end the AI/ML model training.

A WTRU may report to the gNB when AI/ML model training has ended. The WTRU may also report the cause of the ending of the AI/ML model training (e.g. whether a compression rate exceeded a threshold, whether an error rate was less than a threshold, etc.). In cases where the AI/ML model training has ended because a new suitable AI/ML model has been determined, the WTRU may report the model (e.g., encoder or decoder AI/ML models) or parameters thereof. Furthermore, the WTRU may begin using the new model to obtain the CSI feedback. In another example, the WTRU may wait until the gNB acknowledges the new AI/ML model suitability before using it (e.g., the gNB sends an approval message regarding the new AI/ML model).

In cases where the AI/ML model training has ended without a new suitable AI/ML model being determined, the WTRU may report to the gNB the failed AI/ML model training. The WTRU may use the previous AI/ML model or revert to fallback CSI feedback reporting (e.g., without AI/ML). The WTRU may request a new AI/ML model or a new AI/ML training occasion.

When a WTRU stops an AI/ML training, it may stop monitoring RSs configured with AI/ML model training.

If a WTRU has not determined a new AI/ML model that is suitable, the WTRU may test the original AI/ML model. The WTRU may indicate to the gNB that no AI/ML models are suitable if the original AI/ML model is determined to not be suitable or to have failed. The suitability of the original model may be determined by comparing the performance of the model to suitability thresholds (e.g., compression rate threshold or error/MMSE threshold) that may be different than the thresholds used to trigger AI/ML training. For example, a training may be triggered if the MMSE error is above a first threshold. The threshold may be used to attempt to find a new model before the original model actually fails. If no new model is found and the original model MMSE error goes above a second threshold, the WTRU may determine that the original AI/ML model has failed. A WTRU may fallback to legacy functions if no new AI/ML model is found and the original model fails or is deemed unsuitable.

A WTRU may be configured with resources on which to feedback CSI reports. Some resources may be configured or reserved for reporting CSI feedback obtained via an AI/ML model (e.g., compressed feedback report). Some resources may be configured or reserved for reporting CSI feedback obtained via legacy methods (e.g., RI, PMI, CQI, LI, CRI, RSSP, RSSI, RSRQ, CO).

A WTRU may be configured with multiple feedback resources for reporting compressed feedback reports. Each resource may enable a different payload. Each resource may enable the reporting of feedback reports with different compression rates. For example, a first feedback resource may enable the reporting of a large payload for low compression rate feedback reports and a second feedback resource may enable the reporting of a smaller payload for higher compression rate feedback reports.

The WTRU may select the feedback resource as a function of the compression rate of the feedback report.

A WTRU may be provided (e.g., dynamically) or configured (e.g., semi-statically) with an identification or indication of feedback resources that occur during or after training occasions. The identification or indication may be included in a signal received by the WTRU triggering training of an AI/ML model.

The WTRU may select an appropriate feedback resource based one or more factors as disclosed herein.

For instance, one factor for determining a feedback resource may be a compression rate. For example, the WTRU may select the feedback resource as a function of the compression rate of the feedback report. For example, the WTRU may select the feedback resource with the smallest payload size that supports the compression rate of the feedback report.

For instance, one factor for determining a feedback resource may be use of a new model. For example, when the WTRU has trained a new suitable model, the WTRU may select a resource configured to be used with a new AI/ML model.

For instance, one factor for determining a feedback resource may be use of the old model. For example, if the WTRU determines that training did not lead to a better model and the WTRU continues using the old or original AI/ML model, the WTRU may select a specific feedback resource.

For instance, one factor for determining a feedback resource may be using fallback or legacy CSI feedback. For example, if no AI/ML is deemed suitable, a WTRU may use a specific feedback resource. In another example, a WTRU may be configured to report legacy feedback at specific time instances. The WTRU may use a feedback resource configured for legacy feedback.

For instance, one factor for determining a feedback resource may be report type. For example, some resources may be associated with CSI feedback reports, and other resources may be associated with reporting of parameters associated with AI/ML model training. For example, the WTRU may be configured with a feedback resource to report information regarding an ongoing or completed AI/ML model training. For example, the WTRU may be configured with a resource to request a new AI/ML model training occasion.

A WTRU may perform an AI/ML model training and may obtain a new AI/ML model (e.g., for the generation of CSI feedback reports). A WTRU may select a first feedback resource as a function of a first AI/ML model and after AI/ML model training, a second feedback resource as a function of the second AI/ML model. In some cases, the two feedback resources may be the same (e.g., using the same configuration, possibly at different time instances). For example, if the first and second AI/ML model produce feedback of the same compression rate, the feedback resources may be the same. In such a case, the WTRU may explicitly indicate to the gNB that the AI/ML model has changed. The indication may be included in a feedback report (e.g., the first feedback report) using the second AI/ML model.

A WTRU may be configured with resources to report that no suitable AI/ML model exists. For example, a WTRU may be triggered to train a new AI/ML model due to an old model no longer being suitable. If the training does not produce a suitable new AI/ML model, the WTRU may use a specific resource to indicate no suitable model exists.

A WTRU may request one or more feedback resources from the gNB. In the request for a new feedback resource, the WTRU may include desired feedback resource parameters that include at least one of: payload size (or associated compression ratio), periodicity of the feedback resource, duration remaining until a future training occasion, and/or AI/ML model parameters (e.g., error performance).

In some cases, a WTRU may be configured with a first feedback resource with a first payload. The first payload may be suitable for the first compression rate of a first AI/ML model. After training a model, the WTRU may obtain a second AI/ML model. The second compression rate of the second AI/ML model may differ from the first compression rate. The WTRU may use an instance of the first feedback resource to report a feedback report (e.g., a first feedback report) obtained from the second AI/ML model (e.g., the retrained AI/ML model).

If the payload of the new feedback report with the second compression rate is less than the available payload of the first feedback resource, the WTRU may include in the feedback report, additional information in addition to the CSI feedback report obtained from the second AI/ML model. The additional information may include at least one of: information in the feedback report indicating the second compression rate or CSI feedback report payload size, which may enable the gNB to reconfigure the WTRU with a feedback resource better matching the new compression rate or feedback report payload; Include legacy CSI feedback report types (e.g., RI, CQI, PMI, CRI, LI, RSSI, RSRP, RSRQ, CO); and/or, AI/ML model parameters for the first or second, encoder or decoder, AI/ML models.

The additional information may also depend on the feedback resource type. For example, if the feedback resource type is a control channel (e.g., PUCCH resource), the WTRU may multiplex the additional information in the feedback report. If the feedback resource type is a data channel (e.g., PUSCH resource), the WTRU may multiplex the additional information or may include the additional information in a MAC CE.

If the payload of the new feedback report with the second compression rate is more than the available payload of the first feedback resource, the WTRU may modify the feedback report by at least one of: segmenting a CSI feedback report into multiple CSI feedback sub-reports and transmitting each sub-report in different feedback resources; including a request for larger feedback resource payload; transmitting legacy CSI feedback (e.g., the WTRU may fallback to legacy CSI feedback, and/or, the WTRU may replace dropped channel values by legacy CSI feedback reports); and/or, transmitting partial CSI feedback report.

For an example regarding transmitting partial CSI feedback report, the WTRU may drop some bits from the report. The dropped bits may be the LSBs of the channel coefficients. The dropped bits may be associated to specific channel coefficients. The dropped bits may correspond to specific channel regions (e.g., subbands, beams or time periods). The dropped bits may correspond to specific reference signals. The dropped bits may correspond to specific antenna ports.

In some embodiments as discussed above, the WTRU or UE may transmit CSI feedback in a legacy mode. For example, the UE may fall back to legacy CSI feedback. In some embodiments, the UE or WTRU may transmit identifiers of dropped channel values or transmit the dropped bits via legacy CSI feedback reports (e.g. non-compressed CSI feedback results).

In some embodiments, the UE or WTRU may transmit a request for a larger feedback resource payload. For example, if high compression rates are unavailable (e.g. legacy CSI feedback is being utilized), the UE or WTRU may first transmit a request for scheduling a larger feedback resource payload (e.g. expanding the amount of time and bandwidth available for transmitting such feedback reports).

In some embodiments, the UE or WTRU may segment or fragment a CSI feedback report into multiple CSI feedback sub-reports, and transmit each sub-report or portion of the report in different feedback resources. In some such embodiments, a sub-field or identifier may be included with each fragment or portion of the report to indicate that it is a portion of the report, to indicate its order relative to other portions (e.g. “fragment 1”, “fragment 2”, or “fragment 1 of 5”, etc.), or any other such identifiers. For example, one or more bits may be allocated to identifying fragment ordering.

For example at 602, the WTRU may be configured with one or more encoder models and a decoder model. At 604, the WTRU may use the identified encoder model to compress CSI measurements. Upon determining to update the model via any of the triggers discussed above, at 606, the WTRU may perform channel measurements or measure channel conditions and train the internal encoder(s) and decoder using the measurements of channel conditions. At 608, the WTRU may determine whether the new encoder model performs better than the previous model (e.g. based on compression rate, error rate, throughput, or any other such condition or combination of conditions or characteristics as discussed above). If so, then at 610 in some embodiments, the WTRU may determine whether the performance improvement is larger than a predetermined value. If so, at 612, the WTRU may inform the gNB or other devices of the new model and switch to using the newly trained encoder module. If not, then at 614 in some embodiments, the WTRU may continue using the original model. This may be done because the performance improvement is minor or negligible and not worth the delay or resources needed for communicating the new model parameters and switching models. If the new encoder model does not perform better than the previous model, then in some embodiments at 616, the WTRU may determine whether the performance degradation from the new model is larger than a configured value. If so, at 618, the WTRU may inform the gNB or other devices that it is switching to a legacy encoder (e.g. one without compression, or one with a predetermined configuration), and may switch to using the legacy encoder. If not, at 620, the WTRU may continue using the original model. This may be done based on whether performance is rapidly degrading (e.g. due to interference).

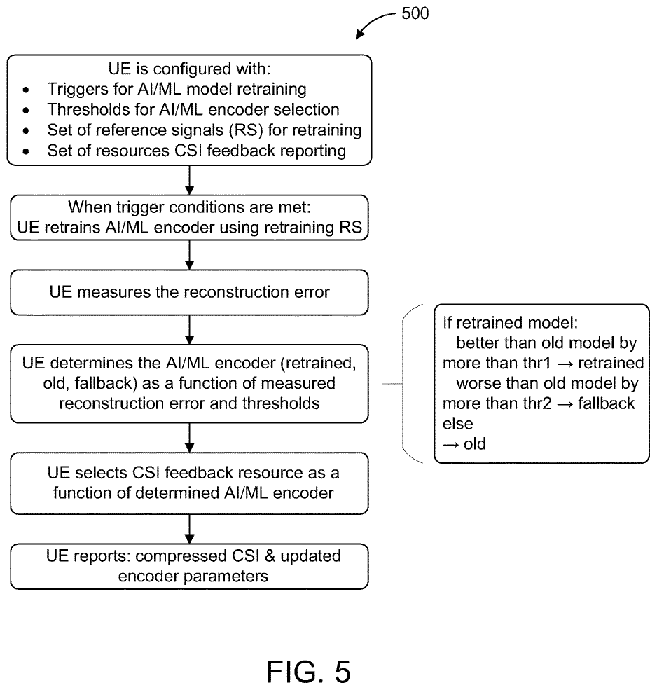

FIG. 5 illustrates an example procedure 500 for AI/ML encoder model online update. In some embodiments, a UE or WTRU may be configured with one or more of triggers for AI/ML model retraining; thresholds for AI/ML encoder selection; a set of one or more reference signals (RS) for retraining; and/or a set of resources for CSI feedback reporting. When trigger conditions are met, in some embodiments, the UE may retrain the AI/ML encoder using retraining RS. The UE may measure the reconstruction error, and determine the AI/ML encoder model to use (e.g. retrained, previous, or a fallback or legacy model or mode) to use as a function of the measured reconstruction error and thresholds. For example, in some embodiments, if the retrained model is better than the old model by more than a first threshold, then the retrained model may be selected. If the retrained model is worse than the old model by greater than a second threshold (which may be equal to or different from the first threshold), then a fallback or legacy model (which may, in some embodiments, include not utilizing compression) may be used. Otherwise, the old (pre-retrained) model may be used. The UE may select a CSI feedback resource as a function of the selected or determined AI/ML encoder, and may transmit a report comprising compressed (or uncompressed, in some instances) CSI feedback and updated encoder parameters.

Accordingly, in some implementations, the systems and methods discussed herein may be implemented by a wireless transmit receive unit (WTRU), and may include receiving configuration information, wherein the configuration information includes one or more of: a first artificial intelligence or a machine learning (AI/ML) model and a second AI/ML model; trigger information related to performing AI/ML model retraining; a set of reconstruction error thresholds for AI/ML model selection; a set of reference signals for measurements for AI/ML model retraining; and/or a set of CSI feedback resources. The WTRU may measure one or more reference signals from the set of reference signals, and may generate a third AI/ML model by retraining the first AI/ML model based on the measuring of the one or more reference signals and the trigger information. The WTRU may measure a reconstruction error for the third AI/ML encoder, and may select an AI/ML model of the first, second, or third AI/ML models (one of which may be a legacy model or even an uncompressed encoding model) based on the measured reconstruction error and a set of AI/ML model selection thresholds. The WTRU may compress a channel state information (CSI) report using the selected one AI/ML model to generate compressed CSI; and may send a message, including one or more of the compressed CSI in a CSI feedback resource of the set of CSI feedback resources or the AI/ML encoder. In some embodiments, the CSI feedback resource is determined based on the selected AI/ML encoder. In some embodiments, the second AI/ML encoder is a fallback encoder.

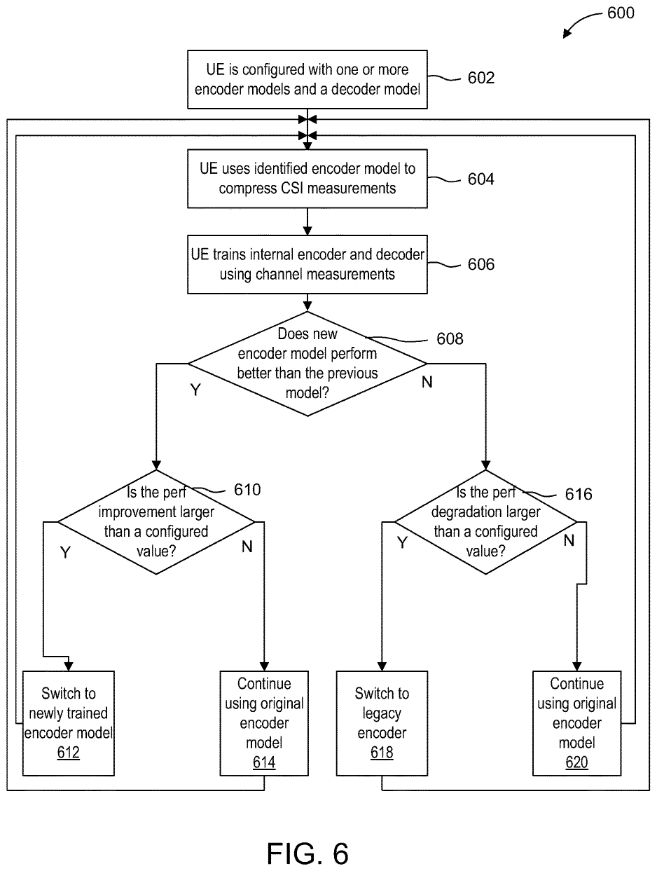

FIG. 6 illustrates an example procedure 600 of performing AI/ML encoder model online update. The WTRU procedures and the decisions in determining usage of the original AI/ML encoder model or the newly re-trained AI/ML encoder model or even fallback to legacy non-AI/ML encoder are shown.

In some cases, the WTRU may determine to update the internally configured AI/ML decoder model due to one or more reasons.

For example, the WTRU may update the AI/ML model based on periodicity. The WTRU may perform online training to update the internal decoder model periodically. The periodicity of the re-training may be configured by the gNB. The WTRU may be configured to re-train a sub-set of the AI/ML decoder model weights or layers by the gNB. The members of the sub-set of the model weights or layers undergoing online re-training may change over time.

For example, the WTRU may update the AI/ML model based on compression quality. The WTRU may determine to perform online re-training when the quality of the encoding-decoding process degrades below a pre-configured threshold. The WTRU may first try out different encoder models paired with the existing AI/ML decoder model. If the quality of the encoding-decoding process is worse than the pre-configured threshold for all the tested encoder models, then the WTRU may determine to re-train the decoder model.

For example, the WTRU may update the AI/ML model based on gNB configuration. The gNB may configure the WTRU to perform online re-training of its internal AI/ML decoder model. The WTRU may be configured to perform the retraining of the decoder model only once per triggering event or may be configured to perform periodic online re-training of the internal decoder model. The WTRU may be provided with training data by the gNB, such as labeled data for training only the decoder model, or some input data (e.g., uncompressed channel matrix for combined re-training of the encoder and the decoder).

The WTRU may inform the gNB when it has successfully re-trained its internal AI/ML encoder model. The WTRU may additionally inform the gNB of the specific AI/ML model weights or layers that have been updated after the online training.

The WTRU, when informing the gNB about successful re-training of its AI/ML decoder model, may also specify the AI/ML encoder model used for the re-training. This may be indicated using an identifier or the AI/ML encoder model weights may be included in the message to the gNB.

The WTRU, upon informing the gNB about the successful update of the internal AI/ML decoder model, may wait to receive a trigger signal from the gNB to start using the re-trained decoder model to test the compression performance. The WTRU may be previously configured for the amount of time it should wait after receiving the trigger signal from the gNB before starting to use the newly re-trained AI/ML decoder model.

The trigger signal from the gNB may be contained in either a MAC Control Element (MAC-CE) message or may be part of the Downlink Control Information (DCI).

The WTRU, upon informing the gNB about the successful update of the internal AI/ML decoder model, may receive a set of weights for the decoder model. These may include updated weights for the entire AI/ML decoder model or portions of the model. The WTRU may also receive a trigger signal from the gNB either simultaneously with the updated model weights or separately. The WTRU may start using the newly configured AI/ML decoder weights after a previously configured delay following the receipt of the trigger signal (e.g. to allow the gNB to begin using the weights with a corresponding encoder).

The WTRU upon failure to receive a trigger signal from the gNB within a specified duration, after informing the gNB about successful re-training of its internal AI/ML decoder model, may switch to the fallback non AI/ML decoder model.

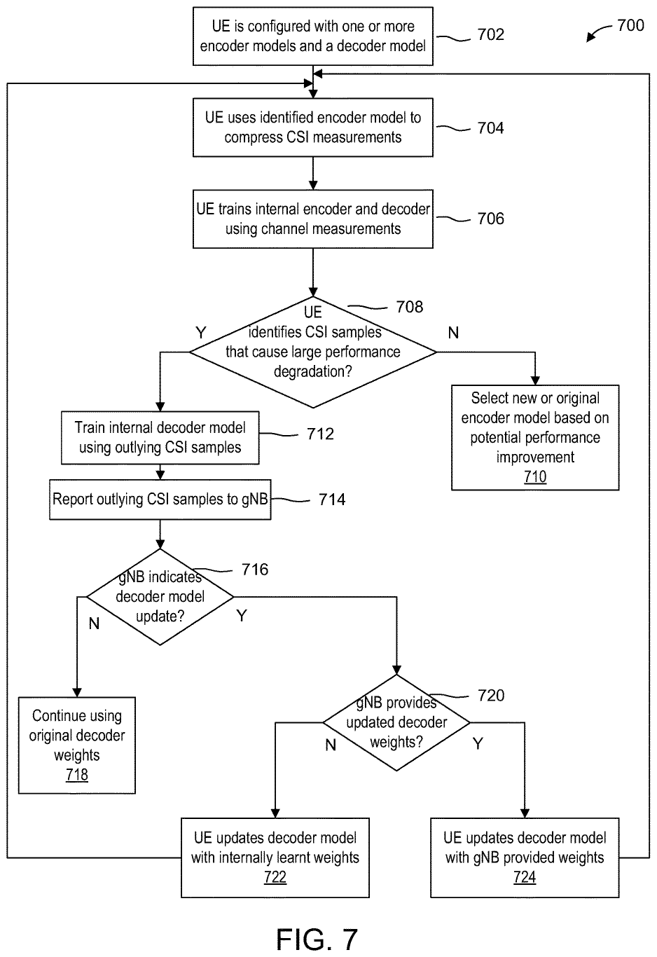

FIG. 7 illustrates another example procedure 700 for an AI/ML decoder model online update. In one embodiment at 702, a WTRU may be configured with one or more AI/ML models for CSI feedback reports (e.g., compression) and at 704 may use an identified encoder model to compress CSI measurements. The WTRU may be configured to perform training (e.g., re-training or online training) of the AI/ML encoder at 706. The WTRU procedures and the decisions in determining usage of the original AI/ML decoder model or the newly re-trained AI/ML decoder model or even fallback to legacy non-AI/ML decoder may be similar to those of procedure 600 as discussed above. In another embodiment however, outlying uncompressed measurements of channel conditions (e.g., outlying CSI values) may be utilized for training. For example, at 708 the WTRU may determine whether there are particular CSI samples that cause a large performance degradation, which may be referred to as outlying samples. If not, then at 710, the WTRU may select a new or original decoder model based on the performance improvement as discussed above in connection with procedure 600. If so, at 712 in some embodiments, the WTRU may retrain the internal decoder model using the outlying CSI samples.

The ML decoder residing at the gNB may be updated as well, periodically or aperiodically. In one embodiment, the WTRU may send one or more data samples (e.g., channel coefficients) for the gNB to re-train the decoder model. In some embodiments, at 714 (either in addition to or instead of 702-712), the WTRU may send the samples that cause large errors (e.g., the WTRU may send the N worst samples). This may include both the uncompressed and compressed channel coefficients (e.g., labeled data). This may allow the gNB may make the ultimate decision to update the decoder model or not.

The WTRU may send the samples either individually, when it comes across them, or in batches when it collects enough of them to fill a pre-configured batch size. Additionally, the WTRU may send the encoder model used by the WTRU to make the failure determination. For this, the WTRU may either send an encoder identifier or the model weights to the gNB.

The requesting WTRU may receive an indication from the gNB when it determines to update its decoder model.

If the gNB uses only the uncompressed and compressed channel samples supplied by the requesting WTRU to update its decoder model, then an indication at 716 when it decides to update the decoder model may be sufficient. Based on the indication, the WTRU may either continue using the original decoder weights at 718 or may update the model with the internally learned weights at 722.

If the gNB determines to use uncompressed and compressed channel samples from more than one WTRU to re-train the decoder model, then it may, in addition to sending an indication when it decides to update the decoder model at 716, send additional uncompressed and compressed channel samples (e.g., labeled data), from other WTRUs to the requesting WTRU for it to re-train its internal decoder model in a similar manner. Explained a different way, these additional samples originate from other WTRUs. The gNB may use them to retrain its decoder model and then sends them to the requesting WTRU so that the requesting WTRU re-trains the decoder at 724 (e.g., which is a replica of the decoder used by the gNB). In some cases, if the gNB re-trains its decoder model, then the requesting WTRU also needs to re-train its replica of the decoder, so they are in-synch.

The WTRU may be pre-configured with decoder parameters used by the gNB for updating its model such as the batch size, other parameters disclosed herein, etc.

In another embodiment, at 714, the WTRU may send only the outlying uncompressed measurements of channel conditions (e.g., outlying CSI values) to the gNB (either after or instead of 702-712). The gNB may then train the auto-encoder with the newly reported uncompressed measurements and then send to the WTRU the updated decoder weights and new or updated encoder weights at 716. Outlying CSI values may be those that result in large error after decompression. The gNB may select an appropriate synthetic dataset upon receiving the uncompressed CSI values from the WTRU for re-training the auto-encoder structure.

The WTRU belonging to a system where there are multiple AI/ML encoder models with a small number of weights and an AI/ML decoder model with a large number of weights may periodically update its encoder model to obtain better compression performance. Additionally, the WTRU may determine to update its internal AI/ML decoder model as well, for example when the compression quality degrades below a pre-determined threshold, such as when the error between the actual uncompressed channel matrix and the channel matrix determined by the encoder and decoder combination is larger than a pre-configured value.

The degradation in compression quality at the WTRU may be caused by, for example, input uncompressed channel matrix values not belonging to the set of values used for initial training of the encoder-decoder pair. These outlying channel matrix values may cause the error at the output of the decoder to be larger than a pre-determined threshold.

The WTRU may send one or more channel matrix values to the gNB for online re-training of the AI/ML decoder model. The data may include both uncompressed channel matrix values as well as compressed outputs of the encoder, such as labeled data. The gNB may then use the labeled data provided by the WTRU to re-train the AI/ML decoder model.

The WTRU, while sending online training data to the gNB, may limit the number of sample values it sends to limit the feedback size. The gNB may then determine the sub-set of channel matrix values that are previously stored internally, to which the WTRU reported values belong to and may use the larger number of values to re-train the AI/ML decoder model. The dataset that is used by the gNB for online training of the AI/ML decoder model may be either selected from one of several data sub-sets that are previously stored, or may be dynamically determined by the gNB upon receiving the data samples from the WTRU. The gNB may determine the appropriate data sub-set, for example, using a similarity measure between the reported channel matrix values and previously stored values such as cosine similarity, normalized mean squared error (NMSE), etc.

The WTRU may determine to send a portion of the samples of the channel matrix values that are determined to cause compression failure. The WTRU may, for example, determine to send the N values that cause the largest compression error. The number of values to report and the thresholds to determine compression failure may be previously configured to the WTRU.

The WTRU may inform the gNB about the encoder model used by the WTRU to make the compression failure determination. The WTRU may either send an encoder identifier to the gNB, or may send the model weights used by the WTRU with the current AI/ML decoder model to the gNB.

The WTRU may send the channel matrix values to the gNB either individually, as they are generated after measurements of channel conditions based on reference signals, or in batches containing multiple such channel matrix values. The size of the batch and/or periodicity of reporting may be pre-configured to the WTRU.

The WTRU, upon sending outlying channel matrix values causing large compression errors to the gNB, may wait to receive the updated AI/ML decoder model weights from the gNB. The WTRU may either receive updated weights for the entire decoder model or some portions of the decoder model. The WTRU may be additionally configured to receive a trigger signal from the gNB to activate the new AI/ML decoder model.

Alternatively, the WTRU, upon sending outlying channel matrix values causing large compression errors to the gNB, may receive from the gNB an additional set of data for online re-training of the AI/ML decoder model. The WTRU may also be provided with an identifier and/or the model weights for the encoder model used by the gNB for updating the AI/ML decoder model weights.

The WTRU may then utilize the data samples that it had determined to cause compression failure along with the additional data provided by the gNB to re-train the AI/ML decoder model. The WTRU may additionally receive a trigger signal from the gNB to indicate when it may start using the newly re-trained AI/ML decoder model.

In an alternative, the WTRU, upon sending outlying channel matrix values causing large compression errors to the gNB, may receive from the gNB an indication when the newly re-trained AI/ML decoder model may be activated. Here the WTRU may use the locally generated data, such as the uncompressed channel matrix values causing compression failure to re-train either whole decoder model or some portions of the decoder model (e.g., certain weights and/or layers).

The data samples that are reported by the WTRU for causing large compression errors and the additional data samples supplied by the gNB to perform AI/ML decoder model re-training may comprise of either uncompressed channel matrix values or a combination of uncompressed channel matrix values and the compressed output from an encoder model, such as labeled data. If only the uncompressed channel matrix values are supplied, then the encoder-decoder pair must be re-trained jointly. However, if the labeled data is provided, then the AI/ML decoder model weights may be trained independently.

The WTRU may first request channel resources from the gNB to send the outlying channel matrix values for re-training of the AI/ML decoder model. The channel resource request may contain an indication of the amount of resources needed to transmit the data.

A WTRU may be configured with one or more AI/ML encoder models (e.g., with a small number of weights) and a mechanism to determine whether the encoded output can be successfully decoded by the AI/ML decoder. For example, this may be used when a WTRU reporting AI/ML based CSI feedback is not configured with an ML decoder model (e.g. a replica of the ML decoder used by the gNB).

In one case, the WTRU may determine a metric associated with the ML encoder output, and compare this metric to a configured value/range. When the WTRU ML encoder output falls outside the configured value/range, a CSI compression error event may occur, indicating that the compressed CSI may not be decoded (decompressed) correctly by the gNB ML decoder.

In another case, the WTRU may use a dedicated ML model to predict the success of the gNB ML decoder (e.g., no CSI compression error event occurs) or the failure of the decoder (e.g., CSI compression error event occurs).

In another case, the WTRU may use a dedicated ML model to predict the CSI reconstruction error; the CSI reconstruction error is a measure of the distance between the CSI decompressed at the gNB ML decoder output, and the actual CSI measured by the WTRU and applied at the WTRU ML encoder input (e.g., the NMSE or the cosine similarity may be used to measure the CSI reconstruction error).

When the WTRU detects a CSI compression error event, the WTRU may send a ML model re-training or a ML model update request to the gNB.

The WTRU may report its capability to detect CSI compression error events. This may include: ML encoder output based; dedicated ML model to predict success/failure of decoding; and/or, dedicated ML model to predict CSI reconstruction error.

The gNB may configure the parameters of the CSI compression error event based on the reported WTRU capability.

For the configured AI/ML encoder model used for CSI compression, the WTRU may receive an indication of a range for the encoder output that would result in successful decoding by the decoder, such as the decoder output varies from the uncompressed channel coefficients by an amount smaller than a threshold.

The default value for the range may be included in the AI/ML model configuration. The range may be semi-statically updated by the gNB via RRC signaling.

The gNB may configure the WTRU with a metric to measure the ML encoder performance, where the metric may be a measure of the distance between the ML encoder output and a reference output that corresponds to a reference uncompressed channel. For example, the metric may be the Frobenius norm of the difference between the ML encoder output and the reference output.

The WTRU may be provided a reference input data (e.g., uncompressed channel coefficients) and the corresponding reference compressed output. The WTRU may calculate the metric between this reference compressed output and the compressed outputs for other inputs (e.g., uncompressed channel coefficients). The WTRU may determine that a CSI compression error event occurs if the calculated metric (e.g., Frobenius norm or the like) exceeds a configured threshold.

An WTRU may be equipped with a dedicated ML model to predict the CSI reconstruction error. The WTRU may be configured with a threshold or set of thresholds for the CSI reconstruction error, based on which to determine whether a CSI compression error event occurs.

The WTRU applies the estimated channel matrix (e.g., uncompressed CSI) to the input of the dedicated ML model. The output of the dedicated ML model may be the predicted CSI reconstruction error.

When the metric for CSI reconstruction error is the cosine similarity, the WTRU may compare the predicted error to a configured (first) threshold. If the predicted error (cosine similarity) is smaller than the configured first threshold, the WTRU may determine that a CSI compression error event occurs.

When the metric for CSI reconstruction error is the NMSE, the WTRU may compare the predicted error to a configured (second) threshold. If the predicted error (NMSE) is larger than the configured second threshold, the WTRU may determine that a CSI compression error event occurs.

When the WTRU detects that a CSI compression error event occurred, the WTRU may report the event to the gNB (e.g., provide CSI feedback report). The WTRU may also be configured to report the estimated CSI reconstruction error.

For the scheduled CSI feedback reporting opportunity, the WTRU may fall back to reporting legacy CSI measurement, for example when the WTRU detects a CSI compression error event.

When the WTRU detects a CSI compression error event, the WTRU may send a ML model re-training or a ML model update request to the gNB. The request may be signaled explicitly (e.g., via RRC signaling), or may be indicated implicitly by the reporting of the CSI compression error event.

In some cases, there may be partial encoder training. The WTRU may be provided with a mapping between certain encoder weights and the reference signal configuration (e.g., either time or frequency configuration such as sub-bands, subcarriers, etc.), such that when the WTRU determines the need to update a limited number of encoder weights, by freezing other weights, it requests for a specific reference signal pattern for online training.

The encoder may be trained to accommodate dis-association between specific channel parameters or channel properties and the weights that they affect. This disassociation of individual parameters or properties may be achieved at several fronts. For example, the dis-association maybe carried out to provide flexible retraining when specific network/hardware enforced parameters like sub-bands, subcarriers, number of transmit/receive antennas, etc., are varied. For example, the dis-association may also be achieved to account for channel properties, that are implicitly impacted by the environment, like, doppler, delay spread, number of multi-paths, channel rank, etc.

The encoder may be trained to accommodate association between specific channel parameters or channel properties and the weights that they affect. This association of individual parameters or properties may be achieved at several fronts. The association may be carried out to provide flexible retraining when specific network/hardware enforced parameters like sub-bands, subcarriers, number of transmit/receive antennas, etc., are varied. The association may also be achieved to account for channel properties, that are implicitly impacted by the environment, like, doppler, delay spread, number of multi-paths, channel rank, etc. In the absence of association, the WTRU may consider that the model weights are independent of the channel properties.

Thus, from the perspective of partial model retraining, the changes in the data dimensionality caused by network/hardware enforced parameters or the data distribution caused by environmental changes may explicitly impact only specific weights within the encoder neural network model.

For the purpose of partial model retraining, it may be required that a list of channel properties or target configurations is predefined. This list may contain one or more of the following parameters, but is not limited to, sub-bands, subcarriers, number of transmit/receive antennas, doppler, delay spread, number of multi-paths, channel rank, etc. For each of these defined parameters the specific weights within the encoder model may be explicitly defined.

Thus for the partial encoder training to be feasible, one or more configurations may be used, each providing different levels of autonomy.

For example, one configuration may be where the encoder model is preconfigured (e.g., in a standard). Additionally, a look-up-table associating the specific weights of the encoder model with each of the channel properties/configurations may also be specified.

For example, one configuration may be where the model is not preconfigured, but the gNB indicates the architecture to the WTRU, and the gNB may also signal the look-up-table providing the weights to channel property/configurations association.

For example, one configuration may be where the model and the look up table are preconfigured at the WTRU (e.g., by a vendor), but it should be ensured that the model and look-up-table adheres to the list of the channel parameters/configurations listed in a standard.

Once the WTRU or gNB have identified the need for encoder re-training, the gNB may further analyze the CSI or may receive inputs from other WTRUs to quantify the degree of change in the channel parameters. Based on this analysis it may indicate to the WTRU the level of retraining required at the WTRU. Considering the example of a convolutional neural network, the gNB may indicate to the WTRU to retrain based on one or more conditions, such as: for large changes in data statistics, or large errors in CSI compression, one or more layers as specified by the look up table; for medium level errors and changes, only a subset of layers maybe updated or specific channels within the layers may be updated; and/or, for small errors and changes, only a (e.g., very small) subset or specific weights within specific layers may be updated.

Once the gNB or WTRU has identified the channel property/configuration that impacts the encoder performance, then the WTRU or gNB may identify the optimal RS density and configuration that may effectively capture the change in the channel associated with the channel property/configuration. For example, if the channel has high doppler the RS symbols may be spread across OFDM symbols to capture the change in a channel across time, whereas if the delay spread is high and doppler is low, the RS symbols may be arranged across the sub-carriers/RBs to ensure that the transition in a channel across frequencies is captured effectively. This may inherently improve the training performance as the data would capture the data statistics more effectively.

If the computation regarding the optimal RS density and configurations is done at the gNB, the RS patterns may be required to be signaled to the WTRU. Alternatively, if the RS pattern computation is done at WTRU, the pattern information may be signaled to the gNB.

According to one or more embodiments herein, there may be techniques and approaches for training AI/ML models used for CSI feedback. These may address one or more issues that arise in wireless systems (e.g., any of the scenarios of FIG. 1), and may help answer questions, such as: How to perform online training of the AI/ML WTRU encoder model, independent from the AI/ML gNB decoder? How does the WTRU determine that the AI/ML network (e.g., gNB) decoder needs updates, and how to indicate the decoder updates to the network? For WTRUs that use AI/ML models pre-trained on a subset of channels, how to request additional training data? These questions, and other related issues that may arise from AI/ML techniques for wireless reporting systems, may find solutions in methods, devices, and/or systems that address situations where the WTRU trains the ML encoder model, and/or where the WTRU determines and assists with updating the ML decoder weights, for example.

In one embodiment, a WTRU may be configured with one or more AI/ML models for CSI feedback reports (e.g., compression) and may use an identified encoder model to compress CSI measurements. The WTRU may be configured to perform training (e.g., re-training or online training) of the AI/ML encoder. The WTRU may be triggered to perform the AI/ML encoder training by: timing; reception of an indicator from the gNB; performance of the WTRU; and/or, performance of the ML model. The WTRU may test an AI/ML model (e.g., the AI/ML encoder model) to determine if it is suitable. For example, the WTRU may use a RS configuration to perform AI/ML encoder training. The WTRU may test the output of the decoder with the actual channel measurement and may determine an error value. The WTRU may compare the error value with a set of thresholds to determine whether to use the newly trained model, or to continue to use the old model, or to switch to legacy CSI reporting. The WTRU may be configured with a set of CSI feedback resources. The WTRU may select an appropriate CSI feedback resource as a function of: the compression rate; the selected AI/ML encoder model; using fallback or legacy CSI report, and report type. The WTRU may request one or more feedback resources from the gNB. The WTRU may include desired feedback parameters (e.g., payload size). The WTRU may be configured with a first feedback resource with a first payload: this may be suitable for a first compression rate of the AI/ML encoder. After training (e.g. re-training, online training), the WTRU may determine a second AI/ML model with a second compression rate. If the payload size associated with the second compression rate is larger than from the first payload size, the WTRU may: include information indicating the second compression rate; transmit partial CSI feedback report; transmit legacy CSI feedback; and/or, segment the CSI feedback report into multiple sub-reports and transmitting each sub-report in different feedback resources.

In one embodiment, the WTRU may update the internal AI/ML decoder model. In one example, the WTRU may compute updated decoder model weights based on outlying channel coefficient values and send them to the gNB. The WTRU may update only a few decoder parameters (freezes some layers) and it only reports the changed decoder parameters. In one example, the WTRU may send only the outlying uncompressed measurements of channel conditions to the gNB. The gNB may then train the auto-encoder with the newly reported uncompressed measurements and then send to the WTRU the updated decoder weights and new or updated encoder weights. In one example, the WTRU may send one or more samples, for the gNB to re-train the decoder model. The WTRU may send the samples that cause large errors, such as the WTRU may send the N worst samples. This may include both the uncompressed and compressed channel coefficients, such as labeled data. The WTRU may send the encoder model that it used to make the failure determination. The gNB may send an indication to the WTRU when it determines to update the decoder model based on WTRU inputs. If the updated decoder model used only the samples supplied by the WTRU, then an indication is sufficient. If the gNB used samples from multiple WTRUs to update the decoder model, then it may send additional samples from other WTRUs for the WTRU to update its AI/ML decoder model.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed in a wireless transmit/receive unit (WTRU), the method comprising:
triggering a retraining of at least one of a plurality of trained artificial intelligence/machine learning (AI/ML) models based on at least one trigger parameter, wherein at least one of the plurality of trained AI/ML models performs compression of channel state information (CSI) feedback;
measuring a reconstruction error of the compressed CSI feedback;
obtaining a CSI feedback report from at least one of the plurality of trained AI/ML models;
determining an AI/ML encoder model status based the measured reconstruction error of the compressed CSI feedback and at least one AI/ML encoder model performance threshold value;
selecting a CSI feedback resource from a set of CSI feedback resources to send the CSI feedback report based on the AI/ML encoder model status; and
sending the CSI feedback report and updated AI/ML encoder parameters via the selected CSI feedback resource according to the determined AI/ML encoder model status.

2. The method of claim 1, wherein the plurality of trained AI/ML models include at least one of: a trained AI/ML encoder model, or a trained AI/ML decoder model.

3. The method of claim 1, wherein the at least one trigger parameter includes: AI/ML encoder model performance threshold values, one or more reference signals (RS) for retraining, CSI feedback resources, or at least one AI/ML retraining trigger condition.

4. The method of claim 3, wherein the at least one AI/ML retraining trigger condition includes: a time period, reception of an indication message, a measure of performance of the WTRU, or a measure of performance of at least one of the plurality of trained AI/ML models.

5. The method of claim 4, wherein the measure of performance of the at least one of the plurality of trained AI/ML models is based on CSI samples.

6. The method of claim 1, wherein the AI/ML encoder model status is one of: a retrained AI/ML encoder model, a previously trained AI/ML encoder model, or a fallback CSI reporting function.

7. The method of claim 6, wherein determining the AI/ML encoder model status comprises:
determining a performance measurement value of the retrained AI/ML encoder model and a performance measurement value of the previously trained AI/ML encoder model; and
comparing the performance measurement value of the retrained AI/ML encoder model to a performance measurement value of the previously trained AI/ML encoder model.

8. The method of claim 7, further comprising:
selecting the retrained AI/ML encoder model in a case where the performance measurement value of the retrained AI/ML encoder model is greater than the performance measurement value of the previously trained AI/ML encoder model by more than a first performance threshold value.

9. The method of claim 7, further comprising:
selecting the fallback CSI reporting function in a case where the performance measurement value of the retrained AI/ML encoder model is less than the performance measurement value of the previously trained AI/ML encoder model by more than a second performance threshold value.

10. The method of claim 7, further comprising:
selecting the previously trained AI/ML encoder model in a case where the performance measurement value of the retrained AI/ML encoder model is less than or equal to a first performance threshold value and equal to or greater than a second performance threshold value.

11. A wireless transmit/receive unit (WTRU) comprising:
processor circuitry configured to:
initiate a retraining of at least one of a plurality of trained artificial intelligence/machine learning (AI/ML) models based on at least one trigger parameter, wherein at least one of the plurality of trained AI/ML models performs compression of channel state information (CSI) feedback;
measure a reconstruction error of the compressed CSI feedback;
obtain a CSI feedback report from at least one of the plurality of trained AI/ML models;
one or more transceivers;
determine an AI/ML encoder model status based the measured reconstruction error of the compressed CSI feedback and at least one AI/ML encoder model performance threshold value; and
select a CSI feedback resource from a set of CSI feedback resources to send the CSI feedback report based on the AI/ML encoder model status; and
a transceiver configured to send the CSI feedback report and updated AI/ML encoder parameters via the selected CSI feedback resource according to the determined AI/ML encoder model status.

12. The WTRU of claim 11, wherein the plurality of trained AI/ML models include at least one of: a trained AI/ML encoder model, or a trained AI/ML decoder model.

13. The WTRU of claim 11, wherein the at least one trigger parameter includes: AI/ML encoder model performance threshold values, one or more reference signals (RS) for retraining, CSI feedback resources, or at least one AI/ML retraining trigger condition.

14. The WTRU of claim 13, wherein the at least one AI/ML retraining trigger condition includes: a time period, reception of an indication message, a measure of performance of the WTRU, or a measure of performance of at least one of the plurality of trained AI/ML models.

15. The WTRU of claim 14, wherein the processor circuitry is configured to measure of performance of the at least one of the plurality of trained AI/ML models is based on CSI samples.

16. The WTRU of claim 11, wherein the AI/ML encoder model status is one of: a retrained AI/ML encoder model, a previously trained AI/ML encoder model, or a fallback CSI reporting function.

17. The WTRU of claim 16, wherein the processor circuitry is further configured to:
determine a performance measurement value of the retrained AI/ML encoder model and a performance measurement value of the previously trained AI/ML encoder model; and
compare the performance measurement value of the retrained AI/ML encoder model to a performance measurement value of the previously trained AI/ML encoder model.

18. The WTRU of claim 17, wherein the processor circuitry is further configured to:
select the retrained AI/ML encoder model in a case where the performance measurement value of the retrained AI/ML encoder model is greater than the performance measurement value of the previously trained AI/ML encoder model by more than a first performance threshold value.

19. The WTRU of claim 17, wherein the processor circuitry is further configured to:
select the fallback CSI reporting function in a case where the performance measurement value of the retrained AI/ML encoder model is less than the performance measurement value of the previously trained AI/ML encoder model by more than a second performance threshold value.

20. The WTRU of claim 17, wherein the processor circuitry is further configured to:
select the previously trained AI/ML encoder model in a case where the performance measurement value of the retrained AI/ML encoder model is less than or equal to a performance threshold value and equal to or greater than a second performance threshold value.
